(19) United States
(12) Patent Application Publication
(10) Pub. No.: US 2018/0055071 A1
(43) Pub. Date: Mar. 1, 2018

(54) ANIMAL FEED COMPOSITIONS

(71) Applicants: Feng Wan, Issaquah, WA (US); Timothy Martin Londergan, Seattle, WA (US); BENEMILK OY, Rasio (FI)

(72) Inventors: Feng Wan, Issaquah, WA (US); Timothy Martin Londergan, Seattle, WA (US)

(21) Appl. No.: 15/560,469

(22) PCT Filed: Mar. 25, 2016
(86) PCT No.: PCT/US16/24309

§ 371 Date: Sep. 21, 2017

Related U.S. Application Data
(60) Provisional application No. 62/214,628, filed on Sep. 4, 2015.
(60) Provisional application No. 62/138,204, filed on Mar. 25, 2015.

(51) Int. Cl. A23K 20/158; A23K 40/35; A23K 50/10; A23K 40/10; A23K 20/20; A23K 20/22; A23K 20/24

(52) U.S. Cl. CPC A23K 20/158; A23K 40/35; A23K 50/10; A23K 20/24; A23K 20/30; A23K 20/22; A23K 40/10

(57) ABSTRACT

A rumen by-pass composition comprises a first component and a second component, wherein the first component comprises a fatty acid salt composition, wherein the second component comprises a free fatty acid composition having a melting point not less than 50° C. and an Iodine Value not greater than 45, and wherein the second component at least partially encapsulates the first component.

### CROSS-REFERENCE TO RELATED APPLICATIONS

This application claims the benefit of U.S. provisional application Nos. 62/138,204, filed on Mar. 25, 2015, and 62/214,628, filed on Sep. 4, 2015, both expressly incorporated herein by reference.

### BACKGROUND

Increasing production and solids content of milk obtained from lactating ruminants have been major goals for dairy farmers. Additional milk production per ruminant is beneficial because it results in a higher yield, thereby increasing profits. Increased milk solids is desirable because milk solids have a high economic value and can be used in highly desirable food products, such as cheese, yogurt, and the like.

Conventional cattle feeds such as corn and alfalfa often fail to provide sufficient energy for cattle, especially lactating dairy cattle during periods of heavy milk production. Feed containing a high proportion of corn also has a tendency to depress the milk fat content of the milk produced by such cattle. Fat is a concentrated energy source, and it is known that if the proportion of fat in cattle feed is increased, lactating daily cattle produce high milk yields without draining their reserves of body fat and without diminishing the proportion of milk fat in the milk produced.

However, it has been found that if the proportion of fat in the diet of cattle exceeds about 5% of the total feed solids, the feed has toxic effects upon the microorganisms in the rumen of the cattle. It appears that fat reduces the growth rate or even kills certain microorganisms which digest fiber in the cow's rumen, thereby lowering fiber digestibility.

There has been a continuing need for new dietary supplements for animal feed that can be fed to ruminant animals without interfering with the rumen microorganisms, or being rendered ineffective by the rumen microorganisms.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a rumen by-pass composition comprises a first component and a second component, wherein the first component comprises a fatty acid salt composition, the second component comprises a free fatty acid composition having a melting point not less than 50° C. and an Iodine Value not greater than 45, and wherein the second component at least partially encapsulates the first component.

In some embodiments, the rumen by-pass composition is a heterogeneous mixture, and wherein the first component is embedded in a matrix comprising the second component.

In some embodiments, the rumen by-pass composition has a core-shell structure having a shell at least partially encapsulating a core, wherein the core comprises the first component, and wherein the shell comprises the second component.

In some embodiments, the ratio of the first component to the second component is from about 1:9 to about 20:1 w/w.

In some embodiments, when administered to a ruminant, the rumen by-pass composition is configured to bypass the rumen.

In some embodiments, from about 40% to about 98% of the rumen by-pass composition by-passes the rumen.

In some embodiments, the rumen by-pass composition is substantially free of glyceride.

In some embodiments, the rumen by-pass composition has an Iodine Value not greater than 30.

In some embodiments, the fatty acid salt composition comprises an alkaline salt, earth metal salt, ammonium salt, or a combination thereof.

In some embodiments, the fatty acid salt composition comprises calcium salt, zinc salt, chromium salt, aluminum salt, selenium salt, cobalt salt, copper salt, iron salt, Manganese salt, molybdenum salt, potassium salt, sodium salt, magnesium salt, tin salt, nickel salt, or a combination thereof.

In some embodiments, the rumen by-pass composition comprises a weight ratio of zinc and manganese from about 1:2 to about 2:1.

In some embodiments, the rumen by-pass composition comprises a weight ratio of zinc to copper from about 8:1 to about 2:1.

In some embodiments, the rumen by-pass composition comprises a weight ratio of copper to molybdenum from about 12:1 to 3:1.

In some embodiments, the rumen by-pass composition comprises a weight ratio of iron to copper from about 20:0.5 to about 20:2.

In some embodiments, the rumen by-pass composition comprises a weight ratio of potassium to sodium from about 5:0.5 to about 5:2.

In some embodiments, the fatty acid salt composition consists essentially calcium salt.

In some embodiments, the fatty acid salt composition comprises a salt of a fatty acid having from about 3 to about 24 carbons.

In some embodiments, the fatty acid salt composition comprises a salt of palmitic acid, stearic acid, oleic acid, linoleic acid, lauric acid, palmitoleic acid, conjugated linoleic acid, linolenic acid, phytanic acid, omega 3 fatty acids, docosahexaenoic acid, and eicosapentaenoic acid, or a combination thereof.

In some embodiments, the fatty acid salt composition comprises a salt of palmitic acid from about 20% to about 55% by weight.

In some embodiments, the fatty acid salt composition comprises a salt of stearic acid from about 1% to about 15% by weight.

In some embodiments, the fatty acid salt composition comprises a salt of oleic acid from about 20% to about 50% by weight.

In some embodiments, the conjugated linoleic acid is selected from the group of conjugated linoleic acid isomers consisting of trans-10, cis-12 conjugated linoleic acid, cis-8, trans-10 conjugated linoleic acid, trans-8, cis-10 conjugated linoleic acid, and a conjugated linoleic acid compound comprising a double bond including carbon number 10, or a mixture comprising at least two of the above compounds.

In some embodiments, the fatty acid salt composition consists essentially of the salt of conjugated linoleic acid.

In some embodiments, the fatty acid salt composition comprises from about 5% to about 50% the salt of conjugated linoleic acid.

In some embodiments, the fatty acid salt composition has an Iodine Value of not greater than 15.

In some embodiments, the first component consists essentially of the fatty acid salt composition.

In some embodiments, the first component has an Iodine Value of not greater than 15.

In some embodiments, the first component further comprises an amino acid, a vitamin, a trace element, a mineral, a glucogenic precursor, an antioxidant, a prebiotic agent, a probiotic agent, an antimicrobial agent, an enzyme, a choline derivative, an energy source, material, a protein material, a carrier, a binding agent, a bulking agent, and a filler, or a combination thereof.

In some embodiments, the free fatty acid composition has an Iodine Value not greater than 6.

In some embodiments, the free fatty acid composition has unsaponifiable matter no greater than 1.5% by weight.

In some embodiments, the free fatty acid composition has a melting point from about 50° C. to about 120° C.

In some embodiments, the free fatty acid composition comprises a palmitic acid compound.

In some embodiments, the first fatty acid composition comprises at least 98% of free palmitic acid by weight.

In some embodiments, the free fatty acid composition comprises a stearic acid compound.

In some embodiments, the free fatty acid composition consists essentially of free palmitic acid, free stearic acid, or a combination thereof. In some embodiments, the ratio of free palmitic acid and free stearic acid is from about 6:4 to about 4:6 w/w.

In some embodiments, the second component has a melting point not less than 50° C. and an Iodine Value not greater than 6.

In some embodiments, the second component has an Iodine Value not greater than 1.

In some embodiments, the second component further comprises a wax.

In some embodiments, the second component further comprises a polymer.

In some embodiments, the second component further comprises an amino acid, a vitamin, a trace element, a mineral, a glucogenic precursor, an antioxidant, a prebiotic agent, a probiotic agent, an antimicrobial agent, an enzyme, an energy source, material, a protein material, a carrier, a binding agent, a bulking agent, and a filler, or a combination thereof.

In some embodiments, the second component further comprises a filler, an antistatic agent, a plasticizer, a colorant, an appetite stimulant, a flavoring agent, a surfactant, or a combination thereof.

In some embodiments, the filler comprises a feed ingredient.

In some embodiments, the flavoring agent comprises bubble gum flavor, butter scotch flavor, cinnamon flavor, an essential oil, a plant extract, a fruit extract, or a combination thereof.

In some embodiments, a dietary composition comprises anyone of the embodiments of the rumen by-pass composition and a feed ingredient.

In some embodiments, the dietary composition is a total mixed ration feed for a ruminant.

In some embodiments, a pelleted feed for a ruminant comprises anyone of the embodiments of the rumen by-pass composition.

In some embodiments, the pelleted feed comprises from about 3% to about 50% by weight of the rumen by-pass composition.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagrammatical illustration of an embodiment of a rumen by-pass composition;

FIG. 2 is a schematic illustration of a method and a system for making a rumen by-pass composition;

FIG. 3 is a schematic illustration of a method and a system for making a rumen by-pass composition; and

FIG. 4 is a schematic illustration of a method and a system for making a rumen by-pass composition.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art.

The following terms shall have, for the purposes of this application, the respective meanings set forth below.

A “ruminant” is generally a suborder of mammal with a multiple chamber stomach that gives the animal the ability to digest cellulose-based food by softening it within a first chamber (rumen) of the stomach and to regurgitate the semi-digested mass to be chewed again by the ruminant for digestion in one or more other chambers of the stomach. Examples of ruminants include, but are not limited to, lactating animals such as cattle, goats and sheep. Cattle may include dairy cows, which are generally animals of the species Bos taurus. The milk produced by ruminants is widely used in a variety of dairy-based products.

The present disclosure generally relates to rumen by-pass compositions, ruminant feed mixtures, the dietary compositions made therefrom, and to the methods for making the dietary compositions that can be fed to ruminants. The dietary compositions may be configured to improve various aspects of milk production in the ruminants. For instance, some embodiments provide that the dietary compositions may increase the amount of milk production by the ruminant, increase the fat content of the milk produced by the ruminant, increase the protein content of the milk produced by the ruminant, or all three. Specific compositions described herein may include ruminant feed mixtures, supplements, additives, or the like. According to some embodiments, the dietary compositions may include solids such as solid particles, pellets, emulsions, or the like.

When a ruminant consumes feed, the fat in the feed is modified by the rumen to provide a milk fat profile that is different from the profile of fat in the feed. All fats that are not completely inert in the rumen may decrease feed intake and rumen digestibility of the feed material or ingredient. Milk composition and fat quality may be influenced by the ruminant's diet. For example, oil feeding (the feeding of vegetable oils, for example) can have negative effects on both rumen function and milk formation. As a result of oil feeding, the milk protein concentration may decrease, the fat concentration may decrease, and the proportion of trans fatty acids may increase. These results have been connected with various negative milk characteristics, such as an increase in the harmful low-density lipoprotein (LDL) cholesterol and a decrease in the beneficial high-density lipoprotein (HDL) cholesterol in human blood when the milk is consumed. In addition, the properties of the milk fat during industrial milk processing may be weakened. A high level of polyunsaturated fatty acids in milk can also cause taste defects and preservation problems. A typical fatty acid composition of milk fat may contain more than about 70% saturated fatty acids and a total amount of trans fatty acids may be from about 3% to about 10%. When vegetable oil is added into the feed, the proportion of trans fatty acids may rise to more than about 10%.

One solution to diminishing the detrimental effect of oil and fat is to prevent fat biohydrogenation in rumen. Fat biohydrogenation can be decreased, for example, by protecting fats with formaldehyde-treated casein. Another alternative is to feed the ruminant insoluble fatty acid calcium salts whereby hydrogenation in the rumen can be reduced. However, fatty acid salts typically have a pungent taste that may result in decreased feed intake by the ruminant. In addition, the salts may also disturb certain processes for forming the feed into pellets.

A rumen by-pass composition, described herein, may improve the pungent taste of fatty acid salts and allow for the transfer of a nutritional agent from the digestive tract into the blood circulation of a ruminant. This may improve the total dry matter intake by the animal and increase energy efficiency of milk production and the utilization of energy by the ruminant. When the utilization of energy becomes more effective, milk production may increase and the concentrations of protein and fat in the milk may rise. According to some embodiments, the dietary composition may be configured to enhance fat synthesis in the mammary gland by bringing milk fat components to the cell such that energy consuming synthesis in the mammary gland is not necessary. As a result, glucose may be used more efficiently for lactose production causing increased milk production. In addition, the milk protein content may increase because there is no need to produce glucose from amino acids. Accordingly, the ruminant may not lose weight at the beginning of the lactation period, thereby improving the fertility of the ruminant.

In one aspect, the application provides rumen by-pass compositions for ruminants. In some embodiments, a rumen by-pass composition, comprises a first component and a second component. The first component comprises a fatty acid salt composition. The second component comprises a free fatty acid composition having a melting point not less than 50° C. and an Iodine Value not greater than 45; and the second component at least partially encapsulates the first component. In some embodiments, the rumen by-pass composition is a heterogeneous mixture, and the first component may be embedded in a matrix comprising the second component. In some embodiments, the matrix may be formed essentially by the second component. In some embodiments, the rumen by-pass composition may have a core-shell structure having a shell at least partially encapsulating a core, wherein the core comprises the first component and the shell comprises the second component. In some embodiments, the rumen by-pass composition may have a core-shell structure having a shell wholly encapsulating a core, wherein the core comprises the first component and the shell comprises the second component.

In some embodiments, the ratio of the first component and the second component is from about 1:9 to about 20:1 w/w. In some embodiments, the ratio may be 1:1, 1:2, 1:3, 1:4, 1:5, 1:10, 10:1, 8:1, 5:1, 3:1, 2:1, or 1:1 w/w. In some embodiments, the ratio is at least 1:1 w/w. In some embodiments, the ration is at most 9:1 w/w. In some embodiments, the first component may include a certain amount of the second component. In some embodiments, the percentage of the second component in the first component does not exceed 50%, 70%, or 80% w/w. In some embodiments, the second component may include a certain amount of the first component. For example, the percentage of the first component in the second component does not exceed 50%, 70%, or 80% w/w. In some embodiments, the second component comprises the first component at a percentage not greater than 50% w/w. In some embodiments, the first component comprises the second component at a percentage not greater than 50% w/w.

The rumen by-pass compositions are configured to protect the composition from rumen bacterial metabolism, i.e., by-pass the rumen. In some embodiments, the rumen bacterial metabolism comprises rumen biohydrogenation. The rumen by-pass compositions are configured to bypass the rumen when administered to the ruminant. In some embodiments, from at least about 50%, 60%, 70%, 80%, or 90% of the rumen by-pass composition by-passes the rumen. In some embodiments, from about 40% to about 98% of the rumen by-pass composition by-passes the rumen. In some embodiments, at least 50% of the rumen by-pass composition by-passes the rumen. In some embodiments, at least 60% of the rumen by-pass composition by-passes the rumen. In some embodiments, at least 70%, 80%, 90% of the rumen by-pass composition by-passes the rumen.

In some embodiments, the weight percentage of the first component in the rumen by-pass composition is from about 5% to about 95%. In some embodiments, the weight percentage of the first component in the rumen by-pass composition does not exceed 90%, 80%, 70%, 60%, 50%, 40%, 30%, 20%, 10%, 5%, or 2%. In some embodiments, the weight percentage of the first component in the rumen by-pass composition is at least 2%, 5%, 10%, 20%, 30%, or 50%.

The rumen by-pass composition may be in free flowing solid form. In some embodiments, the rumen by-pass composition may be formed as solid particles such as, without limitation, spherical beads, oval beads, flakes, granules, pellets, or a combination thereof. The solid particle may have a diameter from about 1 μm to about 20 mm. In some embodiments, the solid particle may have a diameter from about 1 μm to about 3 mm, from about 1 μm to about 10 mm, from about 10 μm to about 2 mm, or from about 100 μm to about 4 mm. In some embodiments, the solid particles have an average particle size of about 1 mm or about 2 mm.

The rumen by-pass composition may have a specific density of from about 0.5 to about 2 or from about 0.8 to about 1.5. In some embodiments, the rumen by-pass composition may have a specific density of about 1. In some embodiments, the rumen by-pass composition has a specific density equal to or bigger than the specific density of the rumen fluid. In some embodiments, the rumen by-pass composition has a specific density that would facilitate the rumen by-pass composition to pass through the rumen within 2, 4, 6, 8, 12, 24, 36, or 48 hours.

In some embodiments, the first component, the second component, or both may be substantially free of glyceride. In some embodiments, the rumen by-pass composition may be substantially free of glyceride. Substantially free of glyceride means that the glyceride comprises about 0, about 0.1, about 0.5, about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, or about 25% by weight glyceride.

The rumen by-pass composition, the first component, or the second component may be highly saturated. In some embodiments, the rumen by-pass composition has an Iodine Value not greater than 30, 20, 15, 12, 6, 3, 2, 1, or 0.5. In some embodiments, the rumen by-pass composition has an Iodine Value not greater than 30, not greater than 15, or not greater than 6.

The rumen by-pass composition may have a melting point not less than 50° C., 60° C., 70° C., 80° C., 90° C., 100° C., 200° C., 300° C. or 400° C. In some embodiments, the rumen by-pass composition may have a melting point from about 50° C. to about 200° C., from about 50° C. to about 100° C., from about 55° C. to about 200° C.

The fatty acid salt in the rumen by-pass composition may be an alkaline salt, earth metal salt, ammonium salt, or a combination thereof. For example, the fatty acid salt composition may include calcium salt, zinc salt, chromium salt, aluminum salt, selenium salt, cobalt salt, copper salt, iron salt, manganese salt, molybdenum salt, potassium salt, sodium salt, magnesium salt, tin salt, nickel salt, or a combination thereof. In some embodiments, the weight ratio of zinc to manganese is from about 1:2 to about 2:1, such as 1:1. In some embodiments, the weight ratio of zinc to copper is from about 8:1 to about 2:1, such as 4:1. In some embodiments, the weight ratio of copper to molybdenum is from about 12:1 to 3:1, such as 6:1. In some embodiments, the weight ratio of iron to copper is from about 20:0.5 to about 20:2, such as 20:1. In some embodiments, the weight ratio of potassium to sodium is from about 5:0.5 to about 5:2 such as 5:1. In some embodiments, the fatty acid salt composition comprises calcium salt, zinc salt, or a combination thereof. In some embodiments, the fatty acid salt composition consists essentially of calcium salt, zinc salt, or a combination thereof.

The fatty acid salt composition may be derived from a fatty acid having from about 2 to about 24 carbons. In some embodiments, the fatty acid salt composition comprises a salt of a fatty acid having 3 to 24 carbons. For example, the fatty acid can have 2, 3, 4, 5, 6, 7, 8, 9, 10, 11, 12, 13, 14, 15, 16, 17, 18, 19, 20, 21, 22, 23, or 24 carbons. In some embodiments, the fatty acid salt composition comprises a salt of a fatty acid having 3 to 18 carbons. The fatty acid may be saturated or unsaturated, mono-saturated or poly-saturated. For example, the fatty acid salt composition may have an Iodine Value of not greater than 15, 12, 6, 5, 2, 1, or 0.5.

In some embodiments, the fatty acid may be palmitic acid, stearic acid, oleic acid, linoleic acid, lauric acid, palmitoleic acid, conjugated linoleic acid, linolenic acid, phytanic acid, omega 3 fatty acids, docosahexaenoic acid, and eicosapentaenoic acid, or a combination thereof. In some embodiments, the fatty acid salt composition comprises a salt of palmitic acid, stearic acid, oleic acid, linoleic acid, lauric acid, palmitoleic acid, conjugated linoleic acid, linolenic acid, phytanic acid, omega 3 fatty acids, docosahexaenoic acid, and eicosapentaenoic acid, or a combination thereof. The conjugated linoleic acid may be selected from the group of conjugated linoleic acid isomers consisting of trans-10, cis-12 conjugated linoleic acid, cis-8, trans-10 conjugated linoleic acid, trans-8, cis-10 conjugated linoleic acid, a conjugated linoleic acid compound comprising a double bond including carbon number 10, or a mixture comprising at least two of the above compounds. In some embodiments, the fatty acid salt composition may include essentially the salt of conjugated linoleic acid. In some embodiments, the fatty acid salt composition comprises from about 5% to about 50% the salt of conjugated linoleic acid. In some embodiments, the fatty acid salt composition comprises at least 25% the salt of conjugated linoleic acid.

In some embodiments, the first component comprises the fatty acid salt composition. In some embodiments, the first component consists essentially of the fatty acid salt composition. In some embodiments, the fatty acid salt composition may include a salt of palmitic acid from about 20% to about 55% by weight. In some embodiments, the fatty acid salt composition may include a salt of stearic acid from about 1% to about 15% by weight. In some embodiments, the fatty acid salt composition may include a salt of oleic acid from about 20% to about 50% by weight. In some embodiments, the fatty acid salt composition may include a salt of lauric acid not greater than 10%. In some embodiments, the fatty acid salt composition comprises a salt of palmitic acid, a salt of stearic acid, or a combination thereof. In some embodiments, the fatty acid salt composition consists essentially of a salt of palmitic acid, a salt of stearic acid, or a combination thereof. In some embodiments, the fatty acid salt composition comprises a salt of palmitic acid, a salt of stearic acid, or a combination thereof.

In some embodiments, the first component has an Iodine Value of not greater than 20, 15, 12, 6, 1, or 0.5.

The first component may further include an amino acid, a lipid, a vitamin, a trace element, a mineral, a glucogenic precursor, an antioxidant, a prebiotic agent, a probiotic agent, an antimicrobial agent, an enzyme, a choline derivative, an energy source, a feed ingredient, a protein material, a carrier, a binding agent, a bulking agent, a filler, or a combination thereof.

The amino acid may be any essential or non-essential amino acids and their derivatives including for example leucine, lysine, histidine, valine, arginine, threonine, isoleucine, phenylalanine, methionine, tryptophan, carnitine, alanine, asparagine, lysine, aspartic acid, cysteine, glutamic acid, glutamine, glycine, valine, ornithine, proline, selenocysteine, selenomethionine, serine, tyrosine, or its derivative thereof. The amino acid may be metal chelated amino acids. In some embodiments, the amino acid may be an amino acid chelated or glycinated with mineral or selenium yeast. For example, the amino acid may be chelated with Zn, Fe, Ca, Se or cobalt.

In some embodiments, the amino acid may be selected from carnitine, histidine, alanine, isoleucine, arginine, leucine, asparagine, lysine, aspartic acid, methionine, cysteine, phenylalanine, glutamic acid, threonine, glutamine, tryptophan, glycine, valine, ornithine, proline, selenocysteine, selenomethionine, serine, tyrosine, or derivatives thereof.

In some embodiments, the amino acid may comprise essential amino acids or their derivatives. In some embodiments, the amino acid may consist essentially of essential amino acids or their derivatives. Example essential amino acids include for example methionine, a methionine derivative, 2-hydroxy-4-methylthio butanoic acid (HMTBa), a HMTBa derivative, lysine, a lysine derivative, or a combination thereof.

In some embodiments, the amino acid may consist essentially of methionine or its derivatives. In some embodiments, the amino acid may comprise methionine or its derivatives. The methionine derivative may be selected from an ester, a thioester, a disulfide derivative, an ether, a thioether, an amide, an imide, a salt, a metal chelated methionine derivative, or a combination thereof. The metal chelated methionine derivative may include a methionine chelated with a metal selected from calcium, sodium, magnesium, phosphorous, potassium, manganese, zinc, selenium, copper, iodine, iron, cobalt, or molybdenum, or a combination thereof.

In some embodiments, the amino acid may consist essentially of lysine or its derivatives. In some embodiments, the amino acid may comprise lysine or its derivatives or a combination. The lysine derivative may be selected from an ester, an amide, an imide, a salt, a metal chelated lysine derivative, or a combination thereof. The metal chelated lysine derivative comprises a lysine chelated with a metal selected from calcium, sodium, magnesium, phosphorous, potassium, manganese, zinc, selenium, copper, iodine, iron, cobalt, molybdenum, or a combination thereof. In some embodiments, the lysine derivative may be a salt of lysine and an organic acid such as acetic acid, propionic acid, butyric acid, pentanoic acid, hexanoic acid, palmitic acid, stearic acid, oleic acid, lauric acid, conjugated linoleic acid, linolenic acid, or a combination thereof. In some embodiments, the organic acid is a free fatty acid having 2-22 carbons.

In some embodiments, the amino acid may comprise methionine or its derivative and lysine or its derivative. In some embodiments, the amino acid consists essentially methionine and lysine. In some embodiments, the amino acid comprises methionine and lysine. In some embodiments, the ratio of methionine or its derivative and lysine or its derivative is from about 1:6 to about 1:2. In some embodiments, the ratio of methionine or its derivative and lysine or its derivative is from about 2:5 to about 2:1.

The lipid may include one or more oils, fats, monoglycerides, diglycerides, triglycerides, or free fatty acids.

The prebiotic agent may include fructo-oligosaccahrides, inulin, galacto-oligosaccharide, mannan-oligosaccharide, a yeast, a yeast derivative, a component of a yeast, a yeast extract, or a combination thereof. In some embodiments, the prebiotic agent includes a yeast derivative.

The probiotics may include lactic acid-producing bacteria, live yeast cells, yeast culture, enzymes (protease and amylase), or a combination thereof.

The antimicrobial comprises monensin, bambermycin, lasalocid, salinomycin, a sesquiterpene, a terpene, an alkaloid, an essential oil, or their derivative thereof.

The antioxidant may include ethoxyquin (1,2-dihydro-6-ethoxy-2,2,4-trimethylquinoline), BHA (butylated hydroxyanisole), BHT (butylated hydroxytoluene), ascorbic acid, ascorbyl palmitate, benzoic acid, calcium ascorbate, calcium propionate, calcium sorbate, citrate acid, dilauryl thiodipropionate, distearyl thiodipropionate, erythorbic acid, formic acid, methylparaben, potassium bisulphite, potassium metabisulphite, potassium sorbate, propionic acid, propyl gallate, propyl paraben, resin guaiae, sodium ascorbate, sodium benzoate, sodium bisulphite, sodium metabisulphite, sodium nitrite, sodium propionate, sodium sorbate, sodium sulphite, sorbic acid, stannous chloride, sulphur dioxide, THBP (trihydroxy-butyrophenone), TBHQ (tertiary-butylhydroquinone), thiodipinic acid, tocopherols, polyphenol, carotenoid, flavonoids, flavones, quinones, anthracenes, a plant extract, a fruit extract, or derivatives thereof.

The glucogenic precursor may include glycerol, propylene glycol, molasses, propionate, glycerine, propane diol, calcium or sodium propionate, polyol, molasses, vinasses, or derivatives thereof.

The vitamin may include at least one of vitamin A, vitamin B, vitamin C, vitamin D, vitamin H, vitamin E, vitamin K, or derivatives thereof. In some embodiments, the vitamin may include thiamine, riboflavin, niacin, pantothenic acid, pyridoxine, biotin, folic acid, cobalamin, carnitine, choline, or its derivative thereof.

The mineral may include any organic or inorganic salt. Representative minerals include a salt of calcium, sodium, magnesium, potassium, phosphorus, zinc, selenium, manganese, iron, cobalt, copper, iodine, molybdenum, an amino acid chelated mineral, an amino acid glycinated mineral, selenium yeast, an organic mineral chelate, an organic mineral glycinate, or a combination thereof. In some embodiments, the mineral is an organic mineral derivative. In some embodiments, the mineral comprises a sodium salt selected from monosodium phosphate, sodium acetate, sodium chloride, sodium bicarbonate, disodium phosphate, sodium iodate, sodium iodide, sodium tripolyphosphate, sodium sulfate, and sodium selenite. In some embodiments, the mineral comprises a calcium salt selected from calcium acetate, calcium carbonate, calcium chloride, calcium gluconate, calcium hydroxide, calcium iodate, calcium iodobehenate, calcium oxide, anhydrous calcium sulfate, calcium sulfate dehydrate, dicalcium phosphate, monocalcium phosphate, and tricalcium phosphate. In some embodiments, the mineral comprises a magnesium salt selected from magnesium acetate, magnesium carbonate, magnesium oxide, and magnesium sulfate. In some embodiments, the mineral comprises a cobalt salt selected from cobalt acetate, cobalt carbonate, cobalt chloride, cobalt oxide, and cobalt sulfate. In some embodiments, the mineral comprises a manganese salt selected from manganese carbonate, manganese chloride, manganese citrate, manganese gluconate, manganese orthophosphate, manganese oxide, manganese phosphate, and manganese sulfate. In some embodiments, the mineral comprises a potassium salt selected from potassium acetate, potassium bicarbonate, potassium carbonate, potassium chloride, potassium iodate, potassium iodide, and potassium sulfate. In some embodiments, the mineral comprises an iron salt selected from iron ammonium citrate, iron carbonate, iron chloride, iron gluconate, iron oxide, iron phosphate, iron pyrophosphate, iron sulfate, and reduced iron. In some embodiments, the mineral comprises a zinc salt selected from zinc acetate, zinc carbonate, zinc chloride, zinc oxide, and zinc sulfate. In some embodiments, the mineral comprises copper sulfate, copper oxide, selenium yeast, and a chelated mineral.

The choline derivative may be choline, choline chloride, choline bi-tartrate, di-hydrogenated citrate of choline, bicarbonate of choline, choline sulphate, choline hydroxide, or a combination thereof.

The energy source may be a carbohydrate material. In some embodiments, the energy source may be a starch, wheat, corn, oat, barley, sorghum, millet, their derivatives, or a combination thereof. In some embodiments, the energy source may be grain flour. In some embodiments, the energy source is a gelatinized starch. In some embodiments, the energy source is steamed grain flour. In some embodiments, the energy source may be steamed corn.

The protein material may include rapeseed meal, soybean meal, sunflower meal, cottonseed meal, camelina meal, mustard seed meal, crambe seed meal, safflower meal, rice meal, peanut meal, corn gluten meal, corn gluten feed, wheat gluten, distillers dried grains, distillers dried grains with solubles, animal protein, or a combination thereof. In some embodiments, the protein material may include blood meal, crab protein concentrate, fish meal, hydrolyzed poultry feather meal, soybean meal, soybean protein concentrate, sunflower seed meal, cotton seed meal, corn gluten meal, alfalfa residues, brewer's residues, meat and bone meal, meat meal, canola meal and poultry by-product meal, or a combination thereof. In some embodiments, the protein material comprises soybean meals, rapeseed meals, sunflower meals, coconut meals, olive meals, linseed meals, grapeseed meals, cottonseed meals, or mixtures thereof. In some embodiments, the protein material may include denatured protein. In some embodiments, the protein material may include cross-linked protein. In some embodiments, the protein material may include partially hydrolyzed protein.

The filler may include a feed ingredient or a mineral. Representative feed ingredients may include without limitation grain, roughage, forage, silage, a protein material, a carbohydrate material, or a combination thereof. In some embodiments, the feed ingredient may include wheat, grains, rapeseed meal, soybean meal, sunflower meal, cottonseed meal, camelina meal, mustard seed meal, crambe seed meal, safflower meal, rice meal, peanut meal, corn gluten meal, corn gluten feed, distillers dried grains, distillers dried grains with solubles, wheat gluten, wheat bran, wheat middlings, wheat mill run, wheat mill run, oat hulls, soya hulls, grass meal, hay meal, alfalfa meal, alfalfa, straw, hay, or a combination thereof.

The antistatic agent may be an oil, a salt or a mineral.

The colorant may be a food or feed grade dye, an antioxidant, a vitamin, a mineral, or a combination thereof. In some embodiments, the colorant may include a flavone, a quinone, a flavanone, an anthracene, a plant extract, a fruit extract, a vitamin, or a combination thereof.

The binding agent may include a synthetic or natural polymer, a polysaccharide or a protein. In some embodiments, the binding agent is a synthetic polymer. In some embodiments, the binding agent is a gelatinized starch.

The bulking agent may include silicate, kaolin, clay, a feed ingredient, a carbohydrate material, a protein material or a combination thereof.

The carrier may be a porous carrier material. In some embodiments, the porous carrier material comprises protein, grain, roughage, metal-organic framework, or a combination thereof.

The free fatty acid composition in the second component may be highly saturated. For example, the free fatty acid composition may have an Iodine Value not greater than 0.5, 1, 2, 5, 6, 7, or 10. In some embodiments, the free fatty acid composition has an Iodine Value not greater than 6, not greater than 1, or from about 0.5 to 6. In some embodiments, the free fatty acid composition has an Iodine Value from about 0.2 to about 6 or from about 0.5 to about 2.

The free fatty acid composition may have unsaponifiable matter no greater than 0.5%, 1.5%, 2%, 3%, 5%, 10%, 15%, 20% or 30% by weight. In some embodiments, the unsaponifiable matter does not exceed 1.5% or 2% by weight.

The free fatty acid composition may have a moisture level of not greater than 1%, 2%, 3% or 5% by weight. In some embodiments, the free fatty acid composition may have a moisture level of not greater than 0.01%.

The free fatty acid composition may have a melting point greater than the physiological temperature of a rumen. In some embodiments, the free fatty acid composition has a melting point not less than 50° C., 54° C., 60° C., 64° C., 70° C., 80° C., 90° C., or 100° C. In some embodiments, the free fatty acid composition may have a melting point not less than 55° C., 60° C., 70° C., or 80° C. In some embodiments, the free fatty acid composition may have a melting point from about 54° C. to about 200° C., or from about 55° C. to about 80° C., or from about 50° C. to about 120° C.

The free fatty acid may include a palmitic acid compound. In some embodiments, the free fatty acid composition may include at least about 98%, 97%, 95%, 94%, 92%, 90%, 85% or 80% of a palmitic acid compound by weight. The palmitic acid compound may include free palmitic acid, a palmitic acid derivative, or both. In some embodiments, the free fatty acid composition may include at least 98% of free palmitic acid by weight. The palmitic acid derivative may include a palmitic acid ester, a palmitic acid amide, a palmitic acid salt, a palmitic acid carbonate, a palmitic acid carbamates, a palmitic acid imide, a palmitic acid anhydride, or a combination thereof.

The free fatty acid composition may include a stearic acid compound. The stearic acid compound may include free stearic acid, a stearic acid derivative, or both. The stearic acid derivative may include a stearic acid ester, a stearic acid amide, a stearic acid salt, a stearic acid carbonate, a stearic acid carbamates, a stearic acid imide, a stearic acid anhydride, or a combination thereof.

In some embodiments, the free fatty acid composition may consist essentially of a palmitic acid compound, a stearic acid compound, or a combination thereof. In some embodiments, the free fatty acid composition may consist essentially of free palmitic acid, free stearic acid, or a combination. In some embodiments, the free fatty acid composition may comprise a palmitic acid compound, a stearic acid combination, or a combination. In some embodiments, the free fatty acid composition may comprise free palmitic acid, free stearic acid, or a combination. In some embodiments, the free fatty acid composition may include free palmitic acid and free stearic acid having a weight/weight ratio from about 10:1 to about 1:10. In some embodiments, the ratio of free palmitic acid to free stearic acid is about 4:6 w/w, about 7:3 w/w, about 1:1 w/w or about 9:1 w/w. In some embodiments, the ratio of free palmitic acid to free stearic acid is about 6:4 to about 4:6. In some embodiments, the ratio of free palmitic acid to free stearic acid is about 8:2 to about 2:8.

The second component may have a melting point at least not less than 50° C. For example, the second component may have a melting point not less than 55° C., 60° C., 70° C., 80° C., or 90° C.

The second component may have an Iodine Value not greater than 6. For example, the second component has an Iodine Value not greater than 0.5, 1, 2, or 3. In some embodiments, the second component has a melting point not less than 50 and an Iodine Value not greater than 6. In some embodiments, the second component has an Iodine Value not greater than 1.

The second component may further comprise an amino acid, a lipid, a vitamin, a trace element, a mineral, a glucogenic precursor, an antioxidant, a prebiotic agent, a probiotic agent, an antimicrobial agent, an enzyme, a choline derivative, an energy source, feed ingredient, a protein material, a carrier, a binding agent, a bulking agent, or a filler. In some embodiments, the second component may further comprise a filler, an antistatic agent, a plasticizer, a colorant, an appetite stimulant, a flavoring agent, a surfactant, or a combination thereof.

The second component may further comprise a wax. The wax may include without limitation a paraffin wax, a natural wax, a synthetic wax, a microcrystalline wax, or a combination thereof. The natural wax may comprise without limitation carnauba wax, beeswax, petroleum wax, rice bran wax, castor wax, their derivatives, or a combination thereof.

The second component may further comprise a polymer. The polymer may comprise a cross-linked polymer. In some embodiments, the polymer may include without limitation polyurethane, polyester, polystyrene, polypyridine, polyvinylpyridine, polycyanate, polyisocynate, polysaccharide, polynucleotide, polyethylene, polyisobutylene, polyvinyl acetate, protein, or a combination thereof.

In some embodiments, the polymer may comprise a denatured protein. In some embodiments, the polymer may comprise a cross-linked protein. In some embodiments, the protein may be cross-linked by reducing sugars. Representative reducing sugars may include without limitation glucose, lactose, fructose, mannose, maltose, ribose, galactose, their derivatives, or a combination thereof. In some embodiments, the protein may be cross-linked by heat-induced formation of disulfide bonds. In some embodiments, the protein may be cross-linked by disulfide bonds, hydrophobic interactions, ionic interactions, hydrogen bonding, or a combination thereof. In some embodiment, the protein may be cross-linked with a divalent linker, formaldehyde, glutaraldehyde, or other aldehydes.

The cross-linked polymer may comprise a vegetable oil. The vegetable oil may be a cross-linked vegetable oil. In some embodiments, the cross-linked vegetable oil may be cross-linked through a divalent linker. In some embodiments, the cross-linked vegetable oil may comprise cross-linked corn oil, cross-linked cottonseed oil, cross-linked peanut oil, cross-linked palm kernel oil, cross-linked soybean oil, cross-linked sunflower oil, or a combination thereof.

The filler may include a feed ingredient or a mineral. Representative feed ingredients may include without limitation grain, roughage, forage, silage, a protein material, a carbohydrate material, or a combination thereof. In some embodiments, the feed ingredient may include wheat, grains, rapeseed meal, soybean meal, sunflower meal, cottonseed meal, camelina meal, mustard seed meal, crambe seed meal, safflower meal, rice meal, peanut meal, corn gluten meal, corn gluten feed, distillers dried grains, distillers dried grains with solubles, wheat gluten, wheat bran, wheat middlings, wheat mill run, wheat mill run, oat hulls, soya hulls, grass meal, hay meal, alfalfa meal, alfalfa, straw, hay, or a combination thereof.

The flavoring agent may an aliphatic alcohol, an aromatic alcohol, an ether, a furan ether, a thiazole alcohol, a pyridine ether, a pyridine alcohol, a benzofuran carbonyl compound, an aliphatic ketone, an aromatic ketone, a α-diketone, a pyrrole-α-diketone, an aromatic sulfur compound, a phenol, an phenol ether, an essential oil, or a derivative thereof.

The flavoring agent may include bubble gum flavor, butter scotch flavor, cinnamon flavor, an essential oil, a plant extract, a fruit extract, or a combination thereof.

The flavoring agent may comprise anethole, benzaldehyde, bergamot oil, acetoin, carvol, cinnamaldehyde, citral, ethylvanillin, vanillin, thymol, methyl salicylate, coumarin, anise, cinnamon, ginger, clove, lemon oil, 1-undecanol, 5-dodecalactone, eugenol, geraniol, geranyl acetate, guaiacol, limonene, linalool, piperonal, 2-acetyl-5-methylpyrazine, 2-ethyl-3-methoxypyrazine, 5-methylquinoxaline, 2methyl-6-propylpyrazine, 2-methylbenzofuran, 2,2′-dithienylmethane, benzyl hexyl carbinol, furfuryl phenyl ether, difurfuryl ether, benzofuran-2-aldehyde, benzothiophene-2-aldehyde, 1-butylpyrrole-2-aldehyde, methyl decyl ketone, dipropyl ketone, ethyl benzyl ketone, 2,6-diacetylpyridine, heptane-3,4-dione, methyl thiophene-2-carboxylate, 2-hydroxyacetophenone, 4-ethyl-2-methoxyphenol, 2-oxobutan-1-ol, or a derivative thereof.

The colorant may be a food or feed grade dye, an antioxidant, a vitamin, a mineral, or a combination thereof. In some embodiments, the colorant may include a flavone, a quinone, a flavanone, an anthracene, a plant extract, a fruit extract, a vitamin, or a combination thereof.

The binding agent may include a synthetic or natural polymer, a polysaccharide or a protein. In some embodiments, the binding agent is a synthetic polymer. In some embodiments, the binding agent is a gelatinized starch.

In another aspect, a dietary composition includes the rumen by-pass composition and a feed ingredient.

In another aspect, a total mixed ration feed for a ruminant comprises anyone of the rumen by-pass compositions disclosed. Total mixed ration feeding is generally understood to be the practice of combining all the ingredients the cow (or other ruminant) needs into a complete feed. For example, each bite or particle of feed includes all the grains, proteins, vitamins, minerals, etc. to meet the dietary needs of the cow (or other ruminant). This way, the cow (or other ruminant) cannot pick and choose what it will eat.

In another aspect, a pelleted feed for a ruminant comprises from about 3% to about 50% by weight of anyone of the rumen by-pass compositions.

In another aspect, the application provides methods for making the rumen by-pass compositions. The methods may include, without limitation, spray mixing, mixing with heating, coating, spraying coating, spin coating, prilling, encapsulation, or a combination thereof.

In another aspect, the application provides systems for making the ruminant by pass composition. The system may include a prilling tower, air-drying apparatus, spray coating apparatus, or a combination thereof.

In another aspect, the application provides feed compositions, including the ruminant by-pass composition and the methods and systems for making such feed compositions. The feed composition may be pelleted feed, meal/mesh feed, total mixed ration feed, partial mixed ration feed, or robotic milking machine feed.

The systems for making such feed compositions may include feed mill system such as a mixer, a conditioner, a hygenizer, an expander, a pelletizer, or a combination thereof.

In a further aspect, the application provides methods of increasing milk fat or protein content of milk produced by a ruminant. In some embodiments, the method includes the steps of providing a rumen by-pass composition to the ruminant for ingestion; and collecting milk from the ruminant after the ruminant has ingested the ruminant feed mixture, wherein milk collected from the ruminant has a higher milk fat content, milk fat yield, milk protein content, or milk protein yield compared to milk before the ruminant ingested the ruminant feed mixture.

The ruminant may be a cow, goat, or sheep.

The application further provides methods for altering the concentration of milk solids in milk produced by a lactating mammal.

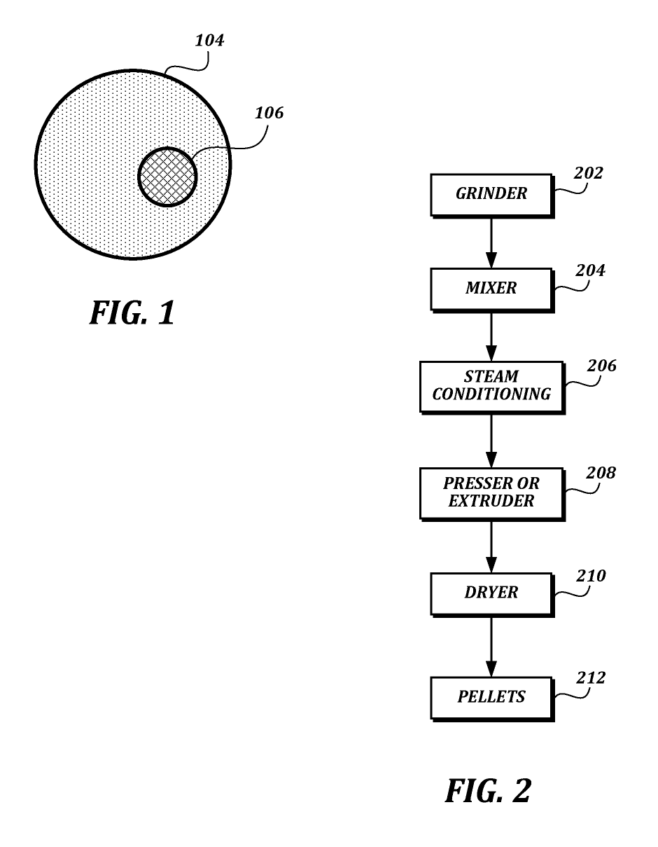

FIG. 1 is a diagrammatical illustration of rumen by-pass composition showing a non-uniform distribution of the first component 106 comprising a fatty acid salt composition and the second component 104 comprising a free fatty acid composition, wherein the second component 104 at least partially encapsulates the first component. In some embodiments, the second component 104 can fully encapsulate the first component 106. In the embodiment illustrated, the first component 106 at the core comprises a fatty acid salt composition and the second component 104 as the outer layer comprises a free fatty acid composition. However, other embodiments may have multiple layers of the second component, and in other embodiments, the first component may include a core a multiple layers surrounding the core.

The rumen by-pass composition of FIG. 1 can be made, for example, by encapsulation methods. The encapsulation process may result in partial or whole encapsulation of the core. The illustrated shape of the rumen by-pass composition is not limiting and can take other shapes depending, for example, on the manufacturing method.

FIG. 2 is a schematic illustration of a system and method of making some embodiments of the rumen by-pass compositions and the dietary compositions. The system of FIG. 2 may be used to make the homogeneous rumen by-pass compositions or the cores of the rumen by-pass compositions, for example. In some embodiments, the system can include a grinder, block 202. Following the grinder, block 202, the system may include a mixer, block 204. The mixer, block 204, can include a paddle mixer or a ribbon mixer. In some embodiments, the system includes a steam conditioning vessel, block 206, in communication with the first mixer, block 204. In some embodiments, following the steam conditioning vessel, the system can include a pellet presser, expander, or extruder, block 208, in communication with the steam conditioning vessel, block 206. In some embodiments, a dryer, block 210 follows the pellet presser, expander, or extruder. The method and system of FIG. 2 can create pellet-shaped rumen by-pass compositions.

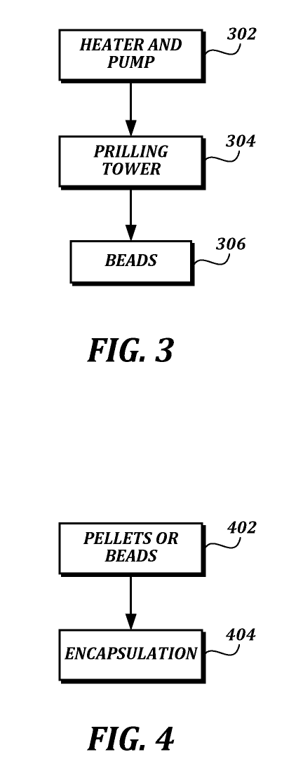

FIG. 3 is a schematic illustration of a system and method of making embodiments of the rumen by-pass compositions. One embodiment of the method employed for making the compositions is referred to as “prilling.” Prilling, also called “spray chilling,” “spray cooling,” or “spray congealing,” generally refers to a process of spraying droplets through nozzles and allowing droplets to congeal in mid-air as they fall from the top of a prilling tower toward a collection surface. Air may be circulated upward through the tower to aid in congealing the droplets into a solid. The size and shape of the droplets may be affected by the height of the tower, the nozzle size, and the nozzle shape. For example, larger sized droplets may require a higher tower than smaller sized droplets. The droplets tend to congeal without agglomerating, and the surface tension of the liquid droplets results in a generally rounded bead surface. In some embodiments, the beads may be round or oval shaped. The system of FIG. 3 may be used to make the rumen by-pass compositions or the cores of the rumen by-pass compositions or make encapsulated rumen by-pass compositions, for example.

In prilling, the material is heated to the melting temperature using a heater, block 302. The temperature leaving the heater can be at or slightly above the melt temperature. The melt can be pumped via a pump, block 302. Then, the melt is distributed through a droplet-producing device at the top of the prilling tower, block 304. As the droplets fall in the tower, the droplets will congeal and solidify by the time they reach the bottom of the tower as solid beads, block 306. Prilling may also be used to make encapsulated compositions. For example, during the descent of the droplets, the encapsulation layer can be sprayed with the encapsulating material from a different nozzle placed at a lower elevation.

FIG. 4 is a schematic illustration of a system and method of encapsulation. In some embodiments, the beads or pellets, block 402, produced by the methods of FIGS. 2 and 3 may be further encapsulated with an encapsulation process, block 404. In some embodiments, the encapsulated rumen by-pass compositions may be manufactured with an encapsulation prilling process, block 404, in which the core material and the outer layer material are sprayed from different nozzles. In some embodiments, the rumen by-pass composition may be encapsulated with a curtain coating process. Other example encapsulation processes, block 404, may include, without limitation, extrusion, co-extrusion, pan coating, fluidized bed, and coacervation.

### EXAMPLES

### Example 1: Preparation of Palmitic Acid Encapsulated Distilled Palm Fatty Acid Salts

A solution of palmitic acid in isopropyl alcohol was added to vigorously stirred distilled palm fatty acid salts so that the solution is distributed uniformly onto the solids. Stirring was continued for 30 minutes for even distribution of the solution. The isopropyl alcohol was removed under reduced pressure and the resulting solid was crushed to a uniform fine powder. Three samples were prepared using three different ratios as shown in TABLE 3. The samples are labeled as 209A, 209B and 209C. It is noted that with increasing amount of palmitic acid coating, the odor of the sample decreases significantly. All samples appeared to be in light tan to cream white color. Comparing to the pungent odor of the distilled palm fatty acid salts, 209A appears to have a faint odor whereas 209B and 209C are close to odorless.

TABLE 3

| | Palmitic acid | Isopropyl alcohol | Fatty acid salts | Yield |
|---|---|---|---|---|
| Sample | (grams) | (ml) | (grams) | (grams) |
| 209A | 10 | 50 | 20 | 29 |
| 209B | 20 | 100 | 20 | 39 |
| 209C | 40 | 200 | 20 | 59 |

### Example 2: Preparation of Palmitic Acid Encapsulated Distilled Palm Fatty Acid Salts

A solution of Palmitic acid (600 g) in isopropanol is slowly dripped into distilled palm fats calcium salts (200 g) under vacuum and in a warm water bath so that the palmitic acid solution is distributed and palmitic acid is coated onto the solid. The isopropanol is removed completely under reduced pressure and the resulting solid is labeled as 209D. The sample appeared to be in light tan to cream white color with a faint pleasant odor.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, recompositions, compounds, compositions or biological systems, which can, of course, vary. It is also to be understood that the terminology used herein is for the purpose of describing particular embodiments only, and is not intended to be limiting.

With respect to the use of plural, singular, or both herein, those having skill in the art can translate from the plural to the singular, from the singular to the plural, or both as is appropriate to the context. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including, but not limited to,” the term “having” should be interpreted as “having at least,” the term “includes” should be interpreted as “includes, but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). In those instances where a convention analogous to “at least one of A, B, or C, et cetera” is used, in general such a construction is intended in the sense one having skill in the art would understand the convention (for example, “a system having at least one of A, B, or C” would include, but not be limited to, systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or FIGURES, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

While illustrative embodiments have been illustrated and described, it will be appreciated that various changes can be made therein without departing from the spirit and scope of the invention.

The embodiments of the invention in which an exclusive property or privilege is claimed are defined as follows:

1. A rumen by-pass composition, comprising a first component and a second component
wherein the first component comprises a fatty acid salt composition,
wherein the second component comprises a free fatty acid composition having a melting point not less than 50° C. and an Iodine Value not greater than 45, and
wherein the second component at least partially encapsulates the first component.

2. The rumen by-pass composition of claim 1, wherein the rumen by-pass composition is a heterogeneous mixture, and wherein the first component is embedded in a matrix comprising the second component.

3. The rumen by-pass composition of claim 1, wherein the rumen by-pass composition has a core-shell structure having a shell at least partially encapsulating a core, wherein the core comprises the first component, and wherein the shell comprises the second component.

4. The rumen by-pass composition of claim 1, wherein the ratio of the first component to the second component is from about 1:9 to about 20:1 w/w.

5. The rumen by-pass composition of claim 1, wherein, when administered to a ruminant, the rumen by-pass composition is configured to bypass the rumen.

6. The rumen by-pass composition of claim 5, wherein from about 40% to about 98% of the rumen by-pass composition by-passes the rumen.

7. The rumen by-pass composition of claim 1, wherein the rumen by-pass composition is substantially free of glyceride.

8. The rumen by-pass composition of claim 1, wherein the rumen by-pass composition has an Iodine Value not greater than 30.

9. The rumen by-pass composition of claim 1, wherein the fatty acid salt composition comprises an alkaline salt, earth metal salt, ammonium salt, or a combination thereof.

10. The rumen by-pass composition of claim 1, wherein the fatty acid salt composition comprises a calcium salt, zinc salt, chromium salt, aluminum salt, selenium salt, cobalt salt, copper salt, iron salt, Manganese salt, molybdenum salt, potassium salt, sodium salt, magnesium salt, tin salt, nickel salt, or a combination thereof.

11. The rumen by-pass composition of claim 10, comprising a weight ratio of zinc to manganese from about 1:2 to about 2:1.

12. The rumen by-pass composition of claim 10, comprising a weight ratio of zinc to copper from about 8:1 to about 2:1.

13. The rumen by-pass composition of claim 10, comprising a weight ratio of copper to molybdenum from about 12:1 to 3:1.

14. The rumen by-pass composition of claim 10, comprising a weight ratio of iron to copper from about 20:0.5 to about 20:2.

15. The rumen by-pass composition of claim 10, comprising a weight ratio of potassium to sodium from about 5:0.5 to about 5:2.

16. The rumen by-pass composition of claim 1, wherein the fatty acid salt composition consists essentially of calcium salt.

17. The rumen by-pass composition of claim 1, wherein the fatty acid salt composition comprises a salt of a fatty acid having from about 3 to about 24 carbons.

18. The rumen by-pass composition of claim 1, wherein the fatty acid salt composition comprises a salt of palmitic acid, stearic acid, oleic acid, linoleic acid, lauric acid, palmitoleic acid, conjugated linoleic acid, linolenic acid, phytanic acid, omega 3 fatty acids, docosahexaenoic acid, and eicosapentaenoic acid, or a combination thereof.

19. The rumen by-pass composition of claim 1, wherein the fatty acid salt composition comprises a salt of palmitic acid from about 20% to about 55% by weight.

20. The rumen by-pass composition of claim 1, wherein the fatty acid salt composition comprises a salt of stearic acid from about 1% to about 15% by weight.

21. The rumen by-pass composition of claim 1, wherein the fatty acid salt composition comprises a salt of oleic acid from about 20% to about 50% by weight.

22. The rumen by-pass composition of claim 18, wherein the conjugated linoleic acid is selected from the group of conjugated linoleic acid isomers consisting of trans-10, cis-12 conjugated linoleic acid, cis-8, trans-10 conjugated linoleic acid, trans-8, cis-10 conjugated linoleic acid, a conjugated linoleic acid compound comprising a double bond including carbon number 10, or a mixture comprising at least two of the above compounds.

23. The rumen by-pass composition of claim 18, wherein the fatty acid salt composition consists essentially of the salt of conjugated linoleic acid.

24. The rumen by-pass composition of claim 18, wherein the fatty acid salt composition comprises from about 5% to about 50% the salt of conjugated linoleic acid.

25. The rumen by-pass composition of claim 1, wherein the fatty acid salt composition has an Iodine Value of not greater than 15.

26. The rumen by-pass composition of claim 1, wherein the first component consists essentially of the fatty acid salt composition.

27. The rumen by-pass composition of claim 1, wherein the first component has an Iodine Value of not greater than 15.

28. The rumen by-pass composition of claim 1, wherein the first component further comprises an amino acid, a vitamin, a trace element, a mineral, a glucogenic precursor, an antioxidant, a prebiotic agent, a probiotic agent, an antimicrobial agent, an enzyme, a choline derivative, an energy source, material, a protein material, a carrier, a binding agent, a bulking agent, and a filler, or a combination thereof.

29. The rumen by-pass composition of claim 1, wherein the free fatty acid composition has an Iodine Value not greater than 6.

30. The rumen by-pass composition of claim 1, wherein the free fatty acid composition has unsaponifiable matter no greater than 1.5% by weight.

31. The rumen by-pass composition of claim 1, wherein the free fatty acid composition has a melting point from about 50° C. to about 120° C.

32. The rumen by-pass composition of claim 1, wherein the free fatty acid composition comprises a palmitic acid compound.

33. The first fatty acid composition of claim 32, comprising at least 98% of free palmitic acid by weight.

34. The first fatty acid composition of claim 1, wherein the free fatty acid composition comprises a stearic acid compound.

35. The first fatty acid composition of claim 1, wherein the free fatty acid composition consists essentially of free palmitic acid, free stearic acid, or a combination thereof.

36. The first fatty acid composition of claim 35, wherein the ratio of free palmitic acid and free stearic acid is from about 6:4 to about 4:6 w/w.

37. The rumen by-pass composition of claim 1, wherein the second component has a melting point not less than 50° C. and an Iodine Value not greater than 6.

38. The rumen by-pass composition of claim 1, wherein the second component has an Iodine Value not greater than 1.

39. The rumen by-pass composition of claim 1, wherein the second component further comprises a wax.

40. The rumen by-pass composition of claim 1, wherein the second component further comprises a polymer.

41. The rumen by-pass composition of claim 1, wherein the second component further comprises an amino acid, a vitamin, a trace element, a mineral, a glucogenic precursor, an antioxidant, a prebiotic agent, a probiotic agent, an antimicrobial agent, an enzyme, an energy source, material, a protein material, a carrier, a binding agent, a bulking agent, and a filler, or a combination thereof.

42. The rumen by-pass composition of claim 1, wherein the second component further comprises a filler, an antistatic agent, a plasticizer, a colorant, an appetite stimulant, a flavoring agent, a surfactant, or a combination thereof.

43. The rumen by-pass composition of claim 42, wherein the filler comprises a feed ingredient.

44. The rumen by-pass component of claim 42, wherein the flavoring agent comprises bubble gum flavor, butter scotch flavor, cinnamon flavor, an essential oil, a plant extract, a fruit extract, or a combination thereof.

45. A dietary composition, comprising the rumen by-pass composition of anyone of claims 1-44 and a feed ingredient.

46. The dietary composition of claim 45, wherein the dietary composition is a total mixed ration feed for a ruminant.

47. A pelleted feed for a ruminant, comprising the rumen by-pass composition of anyone of claims 1-44.

48. The pelleted feed of claim 47, comprising from about 3% to about 50% by weight of the rumen by-pass composition.
